(19) United States
(12) Patent Application Publication
(10) Pub. No.: US 2007/0003226 A1
(43) Pub. Date: Jan. 4, 2007

(54) Audio/image playback apparatus and operation control method

(75) Inventors: Kiyoshi Hoshino, Ome-shi (JP); Koji Shimoda, Hamura-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/474,959

(22) Filed: Jun. 27, 2006

(30) Foreign Application Priority Data
Jun. 29, 2005 (JP) 2005-190098

(51) Int. Cl. H04N 7/00

(52) U.S. Cl. 386/95

(57) ABSTRACT

According to one embodiment, an audio/image playback apparatus includes a storage unit which stores audio/image data containing encoded image data and encoded audio data, a separation unit which separates the image data and the audio data contained in the audio/image data, a first data processing unit which decodes the separated audio data, a second data processing unit which decodes the separated image data, an audio output unit which outputs the decoded audio data, an image output unit which outputs the decoded image data, and a control unit which causes the first data processing unit to decode the audio data, and causes the second data processing unit to stop decoding the image data, based on a predetermined instruction input.

### CROSS-REFERENCE TO RELATED APPLICATIONS

This application is based upon and claims the benefit of priority from Japanese Patent Application No. 2005-190098, filed Jun. 29, 2005, the entire contents of which are incorporated herein by reference.

### BACKGROUND

1. Field

One embodiment of the invention relates to an audio/image playback apparatus which plays back audio/image data. Another embodiment of the invention relates to an operation control method which can be applied to the audio/image playback apparatus.

2. Description of the Related Art

In recent years, a mobile terminal (audio/image playback apparatus) which allows a user to view a moving image remarkably prevails, and a strong demand arises for prolonging the continuous playback time of such mobile terminal as long as possible. To meet this demand, various techniques for decreasing power consumption are proposed.

For example, in Jpn. Pat. Appln. KOKAI Publication No. 2003-187517, the following technique is disclosed. In this technique, in order to play back data from a hard disc drive in which multimedia data such as audio and moving images are recorded, the data is read out in a normal mode at a high playback rate, or in a power saving mode at a low playback rate to optimize power consumption.

These days, contents such as a music promotion video which can be enjoyed only by playing back a music portion is popular. When such contents are to be enjoyed using a mobile terminal driven by a battery or battery cell in a scene unsuitable for viewing video contents, the mobile terminal preferably stops outputting video contents and outputs only music contents. However, since a conventional mobile terminal assumes that a user always views video contents while outputting them, a screen cannot be turned off while outputting video contents.

As described above, the conventional mobile terminal cannot stop decoding and outputting video data even when the user only wants to listen to the music portion, resulting in inconvenience. Also, in such scene unsuitable for viewing video contents, a demand also arises for outputting only a music portion to decrease power consumption.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is a schematic view of a moving image playback apparatus according to an embodiment of the invention;

FIG. 2 is a block diagram showing the flow of playback output of audio and video data in the moving image playback apparatus according to the embodiment;

FIG. 3 is a block diagram showing the flow of playback output of only audio data in the moving image playback apparatus according to the embodiment;

FIG. 4 is a block diagram showing a schematic internal arrangement of a moving image playback apparatus according to a first embodiment of the invention;

FIG. 5 is a table for explaining power saving modes A and B in the moving image playback apparatus shown in FIG. 4 according to the first embodiment;

FIG. 6 is a block diagram showing a schematic internal arrangement of a moving image playback apparatus according to a second embodiment of the invention; and

FIG. 7 is a table for explaining power saving modes A, B, and C in the moving image playback apparatus shown in FIG. 6 according to the second embodiment.

### DETAILED DESCRIPTION

Various embodiments according to the invention will be described hereinafter with reference to the accompanying drawings. In general, according to one embodiment of the invention, an audio/image playback apparatus comprises a storage unit configured to store audio/image data which contains encoded image data and encoded audio data, a separation unit configured to separate the image data and the audio data which are contained in the audio/image data, a first data processing unit configured to decode the separated audio data, a second data processing unit configured to decode the separated image data, an audio output unit configured to output the decoded audio data, an image output unit configured to output the decoded image data, and a control unit configured to cause the first data processing unit to decode the audio data, and cause the second data processing unit to stop decoding the image data, based on a predetermined instruction input.

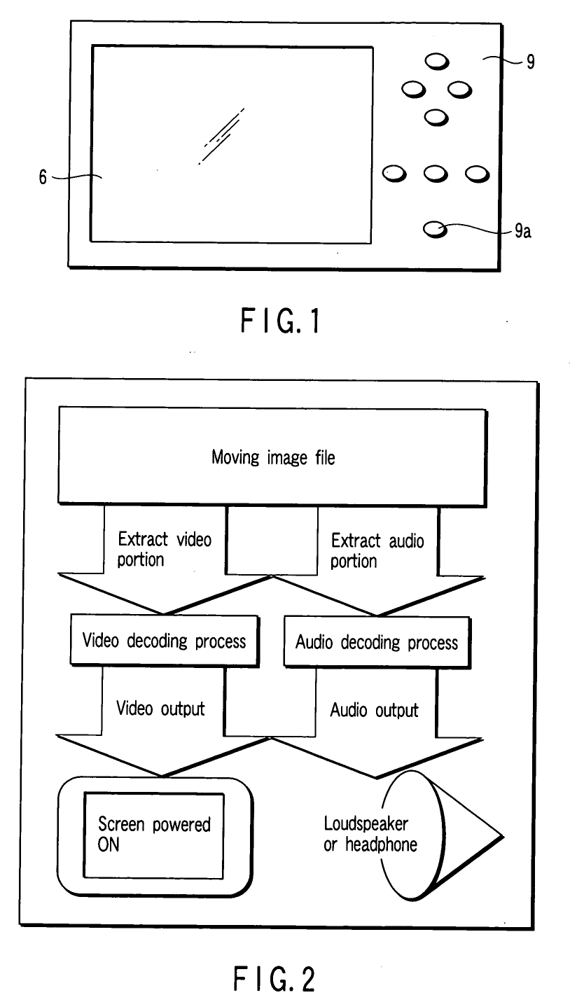

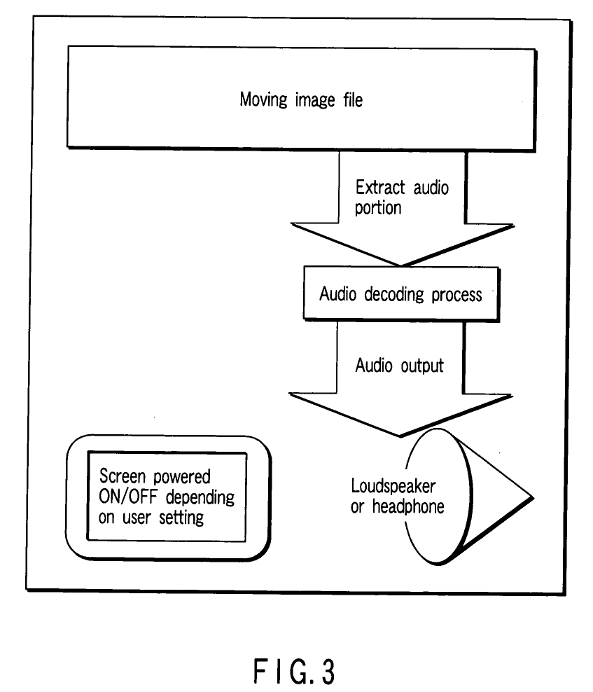

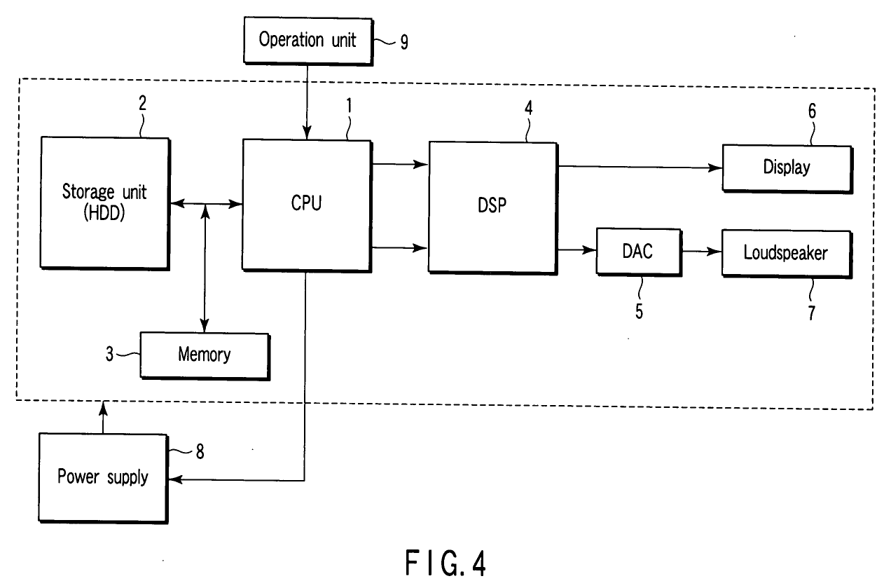

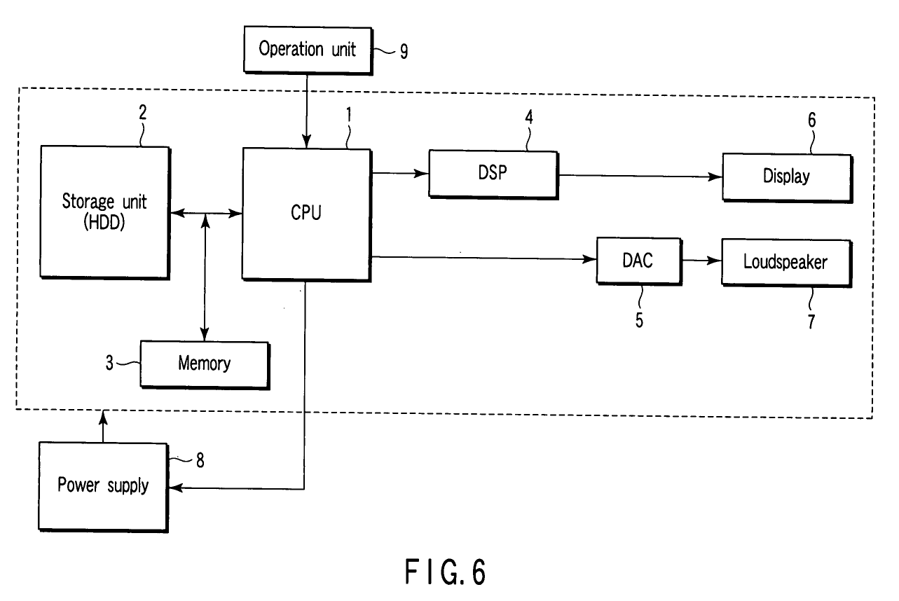

FIG. 1 is a schematic view of a moving image playback apparatus according to an embodiment of the invention. FIG. 2 is a block diagram showing the flow of playback output of audio and video data in the moving image playback apparatus according to the embodiment. FIG. 3 is a block diagram showing the flow of playback output of only audio data in the moving image playback apparatus according to the embodiment. FIG. 4 is a block diagram showing a schematic internal arrangement of a moving image playback apparatus according to a first embodiment of the invention. FIG. 6 is a block diagram showing a schematic internal arrangement of a moving image playback apparatus according to a second embodiment of the invention.

As shown in FIGS. 4 and 6, a moving image playback apparatus includes a CPU 1, storage unit (HDD) 2, memory (buffer) 3, DSP (digital servo processor) 4, DAC (digital/analog converter) 5, display 6, loudspeaker 7, power supply 8, and input unit 9.

Referring to FIGS. 2 and 4, the playback output of audio and video data in the moving image playback apparatus according to the first embodiment will be described first. The storage unit 2 of this moving image playback apparatus stores, e.g., digital audio/image data each including encoded image and audio data. For example, this digital audio/image data is a content purchased via the Internet. As the format of this digital audio/image data, for example, MPEG (Moving Picture Experts Group) 2, MPEG4, WMV (Windows Media Video), H.264 (ITU-T recommendation H.264), or AC (Audio Code number)-3 is available. That is, this moving image playback apparatus has a function of decoding the digital audio/image data.

Upon load control of the CPU 1, digital audio/image data stored in the storage unit 2 is loaded to the memory 3. The memory 3 serves as a buffer. That is, the storage capacity of the memory 3 is smaller than that of the storage unit 2. When the storage unit 2 comprises an HDD, the power consumption efficiency degrades when this HDD always runs during playback of the digital audio/image data. To cope with this problem, part of the digital audio/imaged data stored in the HDD is loaded to the memory 3, and the HDD stops running during playback output of the part of the data which has been loaded to the memory 3 (however, power is kept supplied to the HDD in order to directly load data from the HDD). Alternatively, power supply to the HDD may be stopped. As a result, power consumption can be suppressed. The larger the storage capacity of the memory 3 becomes, the lower power consumption becomes. On the other hand, the cost of the moving image playback apparatus increases. To cope with this problem, this moving image playback apparatus has various power consumption suppressing functions (power saving modes A and B to be described later).

The digital audio/image data loaded to the memory 3 is supplied to the CPU 1. The CPU 1 separates image data and audio data which are contained in the digital audio/image data. That is, the CPU 1 extracts a video portion and an audio portion. The CPU 1 also decodes the separated audio data, and outputs the decoded audio data and the undecoded image data to the DSP 4. The DSP 4 decodes the image data, outputs the decoded image data to the display (display terminal) 6, and outputs the decoded audio data to the DAC 5. That is, the audio data decoded by the CPU 1 is output via the DSP 4. The DAC 5 converts the digital audio data into analog audio data, amplifies the analog audio data as needed, and then outputs the analog audio data to the loudspeaker (loudspeaker terminal) 7.

Accordingly, video contents are displayed on the display 6, and audio contents are output from the loudspeaker 7. The user can enjoy video and audio contents at the same time.

Subsequently, referring to FIGS. 3 and 4, the flow of playback output of only audio data will be described below. When a user wants to enjoy only an audio portion, the user presses an audio playback button (power saving mode button) 9a of the input unit 9. In response to this operation, the input unit 9 outputs the instruction of a power saving mode to the CPU 1. Based on this instruction of the power saving mode, the CPU 1 causes the DSP 4 to stop decoding image data. That is, the CPU 1 separates image data and audio data which are contained in the digital audio/image data, decodes the separated audio data, and outputs the decoded audio data and the undecoded imaged data to the DSP 4. The DSP 4 outputs the decoded audio data to the DAC 5 without decoding the image data (without outputting the image data). As a result, audio contents are output from the loudspeaker 7, but video contents are not displayed on the display 6, thereby suppressing power consumption.

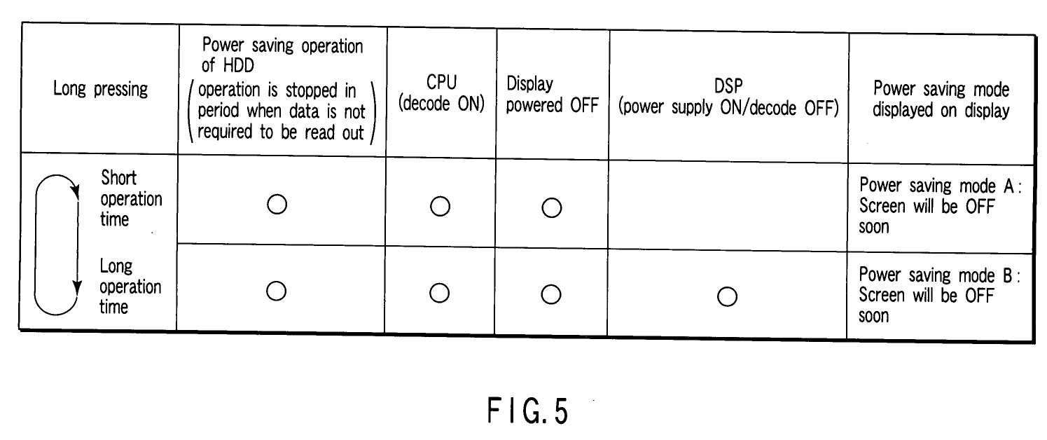

Furthermore, referring to FIG. 5, power saving modes A and B in the moving image playback apparatus shown in FIG. 4 will be described below. When the audio playback button (power saving mode button) 9a of the input unit 9 is kept pressed for a predetermined period of time (long pressing for the first period), the input unit 9 outputs the instruction of the power saving mode A to the CPU 1. Furthermore, when the audio playback button (power saving mode button) 9a of the input unit 9 is kept pressed for a predetermined period of time (long pressing for the second period), the input unit 9 outputs the instruction of the power saving mode B to the CPU 1. After that, when the audio playback button (power saving mode button) 9a of the input unit 9 is kept pressed for a predetermined period of time, the input unit 9 outputs the instruction of the power saving mode A to the CPU 1 again.

Based on the instruction of the power saving mode A, the CPU 1 supplies power to each unit (such as the DSP 4, DAC 5, display 6, loudspeaker 7, and the like). For example, the display 6 displays a guide indicating “Power saving mode A: Screen will be OFF soon”. After a predetermined period of time (e.g., after 10 sec), the CPU 1 stops power supply to the display 6, collectively loads, to the memory 3, part of digital audio/image data corresponding to a predetermined playback time in the storage unit 2, and then stops the operation of the storage unit 2. When the data amount in the memory 3 becomes short, the CPU 1 reactivates the storage unit 2, and collectively loads, to the memory 3, part of digital audio/image data corresponding to a predetermined playback time in the storage unit 2.

The CPU 1 receives the digital audio/image data from the memory 3, separates the image data and the audio data which are contained in the digital audio/image data, decodes the separated audio data, and outputs the decoded audio data and the undecoded image data to the DSP 4. The DSP 4 decodes the image data, outputs the decoded image data to the display 6, and outputs the decoded audio data to the DAC 5. As a result, audio contents are output from the loudspeaker 7, but an image is not displayed on the display 6 because power supply to the display 6 is stopped.

As described above, power consumption can be suppressed by operating the storage unit 2 only when required, and stopping power supply to the display 6 at a predetermined timing. Also, since the DSP 4 always decodes the imaged data, the power saving mode A is released upon input operation of the operation unit 9. Accordingly, a normal viewing mode (output of audio and video data) is executed, and the image is displayed on the display 6 immediately after supplying power to the display 6. That is, audio and video contents can be enjoyed immediately after executing the normal viewing mode.

Based on the instruction of the power saving mode B, the CPU 1 supplies power to each unit (such as the DSP 4, DAC 5, display 6, loudspeaker 7, and the like). For example, the display 6 displays a guide indicating “Power saving mode B: Screen will be OFF soon”. After a predetermined period of time (e.g., after 10 sec), the CPU 1 stops power supply to the display 6, collectively loads, to the memory 3, part of digital audio/image data corresponding to a predetermined playback time in the storage unit 2, and then stops the operation of the storage unit 2. When the data amount in the memory 3 becomes short, the CPU 1 reactivates the storage unit 2, and collectively loads, to the memory 3, part of digital audio/image data corresponding to a predetermined playback time in the storage unit 2.

The CPU 1 receives the digital audio/image data from the memory 3, separates the image data and the audio data which are contained in the digital audio/image data, decodes the separated audio data, and outputs the decoded audio data and the undecoded image data to the DSP 4. The DSP 4 outputs the decoded audio data to the DAC 5 without decoding the image data (power supply ON/decode OFF). As a result, audio contents are output from the loudspeaker 7, but neither power nor video is supplied to the display 6.

As described above, power consumption can be widely suppressed by operating the storage unit 2 only when required, causing the DSP to stop decoding, and stopping power supply to the display 6 at a predetermined timing. Also, since the DSP 4 always receives power supply, the power saving mode B is released upon input operation of the operation unit 9. Accordingly, the normal viewing mode (output of audio and video data) is executed, and the DSP 4 can start decoding image data immediately after supplying power to the display 6. That is, audio and video contents can be enjoyed immediately after executing the normal viewing mode.

Referring to FIGS. 2 and 6, the audio/video playback output of a moving image playback apparatus according to the second embodiment will be described below. Upon load control of a CPU 1, digital audio/image data stored in a storage unit 2 is loaded to a memory 3. The memory 3 serves as a buffer. That is, the storage capacity of the memory 3 is smaller than that of the storage unit 2. When the storage unit 2 comprises an HDD, the power consumption efficiency degrades when this HDD always runs during playback of the digital audio/image data. To cope with this problem, part of the digital audio/imaged data stored in the HDD is loaded to the memory 3, and the HDD stops running during playback output of the part of the data which has been loaded to the memory 3 (however, power is kept supplied to the HDD in order to directly load data from the HDD). Alternatively, power supply to the HDD may be stopped. As a result, power consumption can be suppressed. The larger the storage capacity of the memory 3 becomes, the lower power consumption becomes. On the other hand, the cost of the moving image playback apparatus increases. To cope with this problem, this moving image playback apparatus has various power consumption suppressing functions (power saving modes A, B, and C to be described later).

The digital audio/image data loaded to the memory 3 is supplied to the CPU 1. The CPU 1 separates image data and audio data which are contained in the digital audio/image data. That is, the CPU 1 extracts a video portion and an audio portion. The CPU 1 also decodes the separated audio data, outputs the decoded audio data to a DAC 5, and outputs the undecoded image data to a DSP 4. The DSP 4 decodes the image data, and outputs the decoded image data to a display (display terminal) 6. The DAC 5 converts the digital audio data into analog audio data, amplifies the analog audio data as needed, and then outputs the analog audio data to a loudspeaker (loudspeaker terminal) 7.

Accordingly, video contents are displayed on the display 6, and audio contents are output from the loudspeaker 7. The user can enjoy video and audio contents at the same time.

Subsequently, referring to FIGS. 3 and 6, the flow of playback output of only audio data will be described below. When a user wants to enjoy only an audio portion, the user presses an audio playback button (power saving mode button) 9a of an input unit 9. In response to this operation, the input unit 9 outputs the instruction of a power saving mode to the CPU 1. Based on this instruction of the power saving mode, the CPU 1 causes the DSP 4 to stop decoding image data. That is, the CPU 1 separates image data and audio data which are contained in the digital audio/image data, decodes the separated audio data, outputs the decoded audio data to the DAC 5, and outputs the undecoded imaged data to the DSP 4. The DSP 4 does not decode the image data (does not output the image data). As a result, audio contents are output from the loudspeaker 7, but video contents are not displayed on the display 6, thereby suppressing power consumption.

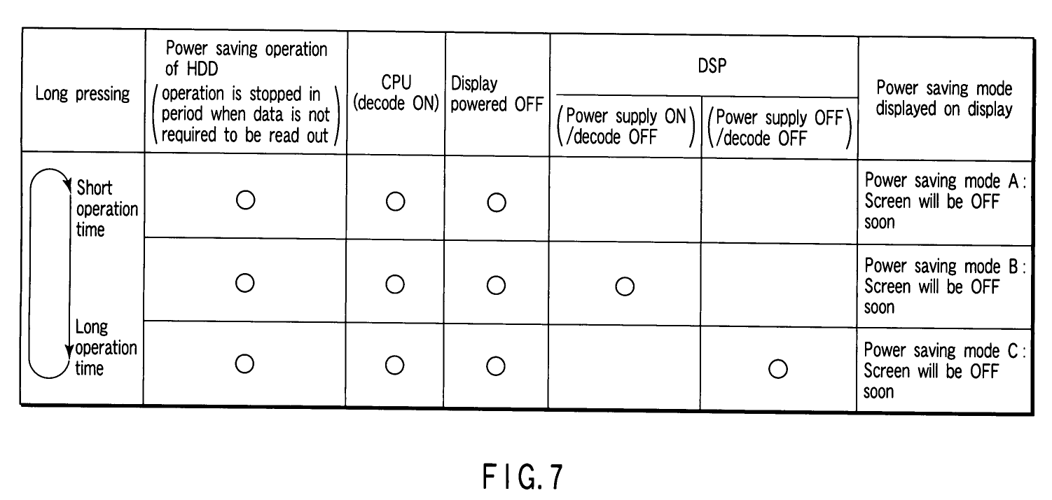

Furthermore, referring to FIG. 7, power saving modes A, B, and C in the moving image playback apparatus shown in FIG. 6 will be described below. When the audio playback button (power saving mode button) 9a of the input unit 9 is kept pressed for a predetermined period of time (long pressing for the first period), the input unit 9 outputs the instruction of the power saving mode A to the CPU 1. Furthermore, when the audio playback button (power saving mode button) 9a of the input unit 9 is kept pressed for a predetermined period of time (long pressing for the second period), the input unit 9 outputs the instruction of the power saving mode B to the CPU 1. When the audio playback button (power saving mode button) 9a of the input unit 9 is further kept pressed for a predetermined period of time (long pressing for the third period), the input unit 9 outputs the instruction of the power saving mode C to the CPU 1. After that, when the audio playback button (power saving mode button) 9a of the input unit 9 is kept pressed for a predetermined period of time, the input unit 9 outputs the instruction of the power saving mode A to the CPU 1 again.

Based on the instruction of the power saving mode A, the CPU 1 supplies power to each unit (such as the DSP 4, DAC 5, display 6, loudspeaker 7, and the like). For example, the display 6 displays a guide indicating “Power saving mode A: Screen will be OFF soon”. After a predetermined period of time (e.g., after 10 sec), the CPU 1 stops power supply to the display 6, collectively loads, to the memory 3, part of digital audio/image data corresponding to a predetermined playback time in the storage unit 2, and then stops the operation of the storage unit 2. When the data amount in the memory 3 becomes short, the CPU 1 reactivates the storage unit 2, and collectively loads, to the memory 3, part of digital audio/image data corresponding to a predetermined playback time in the storage unit 2.

The CPU 1 receives the digital audio/image data from the memory 3, separates the image data and the audio data which are contained in the digital audio/image data, decodes the separated audio data, outputs the decoded audio data to the DAC 5, and outputs the undecoded image data to the DSP 4. The DSP 4 decodes the image data, and outputs the decoded image data to the display 6. As a result, audio contents are output from the loudspeaker 7, but an image is not displayed on the display 6 because power supply to the display 6 is stopped.

As described above, power consumption can be suppressed by operating the storage unit 2 only when required, and stopping power supply to the display 6 at a predetermined timing. Also, since the DSP 4 always decodes the imaged data, the power saving mode A is released upon input operation of the operation unit 9. Accordingly, a normal viewing mode (output of audio and video data) is executed, and the image is displayed on the display 6 immediately after supplying power to the display 6. That is, audio and video contents can be enjoyed immediately after executing the normal viewing mode.

Based on the instruction of the power saving mode B, the CPU 1 supplies power to each unit (such as the DSP 4, DAC 5, display 6, loudspeaker 7, and the like). For example, the display 6 displays a guide indicating “Power saving mode B: Screen will be OFF soon”. After a predetermined period of time (e.g., after 10 sec), the CPU 1 stops power supply to the display 6, collectively loads, to the memory 3, part of digital audio/image data corresponding to a predetermined playback time in the storage unit 2, and then stops the operation of the storage unit 2. When the data amount in the memory 3 becomes short, the CPU 1 reactivates the storage unit 2, and collectively loads, to the memory 3, part of digital audio/image data corresponding to a predetermined playback time in the storage unit 2.

The CPU 1 receives the digital audio/image data from the memory 3, separates the image data and the audio data which are contained in the digital audio/image data, decodes the separated audio data, outputs the decoded audio data to the DAC 5, and outputs the undecoded image data to the DSP 4. The DSP 4 does not decode the image data (power supply ON/decode OFF). As a result, audio is output from the loudspeaker 7, but neither power nor video is supplied to the display 6.

As described above, power consumption can be widely suppressed by operating the storage unit 2 only when required, causing the DSP to stop decoding, and stopping power supply to the display 6 at a predetermined timing. Also, since the DSP 4 always receives power supply, the power saving mode B is released upon input operation of the operation unit 9. Accordingly, the normal viewing mode (output of audio and video data) is executed, and the DSP 4 can start decoding image data immediately after supplying power to the display 6. That is, audio and video contents can be enjoyed immediately after executing the normal viewing mode.

Based on the instruction of the power saving mode C, the CPU 1 supplies power to each unit (such as the DSP 4, DAC 5, display 6, loudspeaker 7, and the like). For example, the display 6 displays a guide indicating “Power saving mode C: Screen will be OFF soon”. After a predetermined period of time (e.g., after 10 sec), the CPU 1 stops power supply to the display 6, stops power supply to the DSP 4 (the DSP 4 is powered OFF), collectively loads, to the memory 3, part of digital audio/image data corresponding to a predetermined playback time in the storage unit 2, and then stops the operation of the storage unit 2. When the data amount in the memory 3 becomes short, the CPU 1 reactivates the storage unit 2, and collectively loads, to the memory 3, part of digital audio/image data corresponding to a predetermined playback time in the storage unit 2.

The CPU 1 receives the digital audio/image data from the memory 3, separates the image data and the audio data which are contained in the digital audio/image data, decodes the separated audio data, outputs the decoded audio data to the DAC 5, and outputs the undecoded image data to the DSP 4. Since the DSP 4 does not receive power supply, the DSP 4 cannot decode the image data (power supply OFF/decode OFF). As a result, audio contents are output from the loudspeaker 7, but neither power nor video is supplied to the display 6.

As described above, power consumption can be widely suppressed by operating the storage unit 2 only when required, stopping power supply to the DSP (power supply OFF/decode OFF), and stopping power supply to the display 6 at a predetermined timing.

As described above, in order to stop video output and play back only audio during playback of a moving image, a portable terminal (moving image playback apparatus) which is driven by a battery or battery cell and plays back a moving image can reduce power consumption to prolong its operation time.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An audio/image playback apparatus comprising:
a storage unit configured to store audio/image data which contains encoded image data and encoded audio data;
a separation unit configured to separate the image data and the audio data which are contained in the audio/image data;
a first data processing unit configured to decode the separated audio data;
a second data processing unit configured to decode the separated image data;
an audio output unit configured to output the decoded audio data;
an image output unit configured to output the decoded image data; and
a control unit configured to cause the first data processing unit to decode the audio data, and cause the second data processing unit to stop decoding the image data, based on a predetermined instruction input.

2. An apparatus according to claim 1, which further comprises an audio data supply unit configured to supply the audio data decoded by the first data processing unit, to the audio output unit via the second data processing unit, and in which the control unit causes the first data processing unit to decode the audio data, and causes the second data processing unit to stop decoding the image data without stopping power supply to the second data processing unit, based on a predetermined instruction input.

3. An apparatus according to claim 1, which further comprises an audio data supply unit configured to supply the audio data decoded by the first data processing unit, to the audio output unit without going through the second data processing unit, and in which the control unit causes the first data processing unit to decode the audio data, and causes the second data processing unit to stop decoding the image data by stopping power supply to the second data processing unit, based on a predetermined instruction input.

4. An apparatus according to claim 1, which further comprises an audio data supply unit configured to supply the audio data decoded by the first data processing unit, to the audio output unit without going through the second data processing unit, and in which the control unit causes the first data processing unit to decode the audio data, causes the second data processing unit to stop decoding the image data without stopping power supply to the second data processing unit, based on a first instruction input, causes the first data processing unit to decode the audio data, and causes the second data processing unit to stop decoding the image data by stopping power supply to the second data processing unit, based on a second instruction input.

5. An apparatus according to claim 1, which further comprises an audio data supply unit configured to supply the audio data decoded by the first data processing unit, to the audio output unit via the second data processing unit, and in which the control unit controls to execute a first power saving mode for causing the first data processing unit to decode the audio data, and stopping power supply to the image output unit, based on a first instruction input, and controls to execute a second power saving mode for causing the first data processing unit to decode the audio data, and causing the second data processing unit to stop decoding the image data by stopping power supply to the image output unit without stopping power supply to the second data processing unit, based on a second instruction input.

6. An apparatus according to claim 1, which further comprises an audio data supply unit configured to supply the audio data decoded by the first data processing unit, to the audio output unit without going through the second data processing unit, and in which the control unit controls to execute a first power saving mode for causing the first data processing unit to decode the audio data, and stopping power supply to the image output unit, based on a first instruction input, controls to execute a second power saving mode for causing the first data processing unit to decode the audio data, and causing the second data processing unit to stop decoding the image data by stopping power supply to the image output unit without stopping power supply to the second data processing unit, based on a second instruction input, and controls to execute a third power saving mode for causing the first data processing unit to decode the audio data, and causing the second data processing unit to stop decoding the image data by stopping power supply to the image output unit, and stopping power supply to the second data processing unit, based on a third instruction input.

7. An apparatus according to claim 6, further comprising an input unit configured to input the first instruction in response to long pressing for a first period, input the second instruction in response to long pressing for a second period different from the first period, and input the third instruction in response to long pressing for a third period different from the first period and the second period.

8. An apparatus according to claim 6, wherein the image output unit displays execution of the first power saving mode based on the first instruction input, displays execution of the second power saving mode based on the second instruction input, and displays execution of the third power saving mode based on the third instruction input.

9. An apparatus according to claim 8, wherein the control unit stops power supply to the image output unit a predetermined period of time after the image output unit displays execution of the first power saving mode, execution of the second power saving mode, and execution of the third power saving mode.

10. An apparatus according to the claim 1, which further comprises a buffer which has a storage capacity smaller than a storage capacity of the storage unit, temporarily stores at least part of audio/image data stored in the storage unit, and supplies the temporarily stored audio/image data to the first data processing unit, and in which the control unit reads out at least part of the audio/image data stored in the storage unit, stores the readout data in the buffer, and stops power supply to the storage unit in a period when the audio/image data is not required to be read out from the storage unit.

11. An operation control method which is configured to be applied to an audio/image playback apparatus including a storage unit configured to store audio/image data which contains encoded image data and encoded audio data, a separation unit configured to separate the image data and the audio data which are contained in the audio/image data, a first data processing unit configured to decode the separated audio data, a second data processing unit configured to decode the separated image data, an audio output unit configured to output the decoded audio data, and an image output unit configured to output the decoded image data, comprising:
causing the first data processing unit to decode the audio data, and causing the second data processing unit to stop decoding the image data, based on a predetermined instruction input.

12. A method according to claim 11, in which the audio/image playback apparatus comprises an audio data supply unit configured to supply the audio data decoded by the first data processing unit, to the audio output unit via the second data processing unit, and which further comprises causing the first data processing unit to decode the audio data, and causing the second data processing unit to stop decoding the image data without stopping power supply to the second data processing unit, based on a predetermined instruction input.

13. A method according to claim 11, in which the audio/image playback apparatus comprises an audio data supply unit configured to supply the audio data decoded by the first data processing unit, to the audio output unit without going through the second data processing unit, and which further comprises causing the first data processing unit to decode the audio data, and causing the second data processing unit to stop decoding the image data by stopping power supply to the second data processing unit, based on a predetermined instruction input.

14. A method according to claim 11, in which the audio/image playback apparatus comprises an audio data supply unit configured to supply the audio data decoded by the first data processing unit, to the audio output unit without going through the second data processing unit, and which further comprises causing the first data processing unit to decode the audio data, causing the second data processing unit to stop decoding the image data without stopping power supply to the second data processing unit, based on a first instruction input, causing the first data processing unit to decode the audio data, and causing the second data processing unit to stop decoding the image data by stopping power supply to the second data processing unit, based on a second instruction input.

15. A method according to claim 11, in which the audio/image playback apparatus comprises an audio data supply unit configured to supply the audio data decoded by the first data processing unit, to the audio output unit via the second data processing unit, and which further comprises controlling to execute a first power saving mode for causing the first data processing unit to decode the audio data, and stopping power supply to the image output unit, based on a first instruction input, and controlling to execute a second power saving mode for causing the first data processing unit to decode the audio data, and causing the second data processing unit to stop decoding the image data by stopping power supply to the image output unit without stopping power supply to the second data processing unit, based on a second instruction input.

16. A method according to claim 11, in which the audio/image playback apparatus comprises an audio data supply unit configured to supply the audio data decoded by the first data processing unit, to the audio output unit without going through the second data processing unit, and which further comprises controlling to execute a first power saving mode for causing the first data processing unit to decode the audio data, and stopping power supply to the image output unit, based on a first instruction input, controlling to execute a second power saving mode for causing the first data processing unit to decode the audio data, and causing the second data processing unit to stop decoding the image data by stopping power supply to the image output unit without stopping power supply to the second data processing unit, based on a second instruction input, and controlling to execute a third power saving mode for causing the first data processing unit to decode the audio data, and causing the second data processing unit to stop decoding the image data by stopping power supply to the image output unit, and stopping power supply to the second data processing unit, based on a third instruction input.

17. A method according to claim 16, further comprising inputting the first instruction in response to long pressing for a first period, inputting the second instruction in response to long pressing for a second period different from the first period, and inputting the third instruction in response to long pressing for a third period different from the first period and the second period.

18. A method according to claim 16, further comprising displaying execution of the first power saving mode based on the first instruction input, displaying execution of the second power saving mode based on the second instruction input, and displaying execution of the third power saving mode based on the third instruction input.

19. A method according to claim 18, further comprising stopping power supply to the image output unit a predetermined period of time after the image output unit displays execution of the first power saving mode, execution of the second power saving mode, and execution of the third power saving mode.

20. A method according to the claim 11, in which the audio/image playback apparatus comprises a buffer which has a storage capacity smaller than a storage capacity of the storage unit, temporarily stores at least part of audio/image data stored in the storage unit, and supplies the temporarily stored audio/image data to the first data processing unit, and which further comprises reading out at least part of the audio/image data stored in the storage unit, storing the readout data in the buffer, and stopping power supply to the storage unit in a period when the audio/image data is not required to be read out from the storage unit.
